(19) United States
(12) Patent Application Publication
(10) Pub. No.: US 2024/0303973 A1
(43) Pub. Date: Sep. 12, 2024

(54) ACTOR-CRITIC APPROACH FOR GENERATING SYNTHETIC IMAGES

(71) Applicant: Bayer Aktiengesellschaft, Leverkusen (DE)

(72) Inventors: Thiago RAMOS DOS SANTOS, London (GB); Veronica CORONA, London (GB); Marvin PURTORAB, Hannover (DE); Sara LORIO, Reading (GB)

(73) Assignee: Bayer Aktiengesellschaft, Leverkusen (DE)

(21) Appl. No.: 18/547,855

(22) PCT Filed: Feb. 16, 2022
(86) PCT No.: PCT/EP2022/053756

§ 371 Date: Aug. 24, 2023

(30) Foreign Application Priority Data
Feb. 26, 2021 (EP) 21159750.5

(51) Int. Cl. G06V 10/774; G06T 11/00; G06V 10/46; G06V 10/764; G06V 10/776; G06V 10/82

(52) U.S. Cl. CPC G06V 10/774; G06T 11/00; G06V 10/462; G06V 10/764; G06V 10/776; G06V 10/82; G06T 2210/41; G06V 2201/03

(57) ABSTRACT

The present invention provides a technique for model improvement in supervised learning with potential applications to a variety of imaging tasks, such as segmentation, registration, detection. In particular, it has shown potential in medical imaging enhancement.

### CROSS REFERENCE TO RELATED APPLICATIONS

This application is a national stage application under 35 U.S.C. § 371 of International Application No. PCT/EP2022/053756, filed internationally on Feb. 16, 2022, which claims priority to European Application No. 21159750.5, filed on Feb. 26, 2021, the entire content of each is hereby incorporated by reference in their entirety.

### FIELD

The present invention provides a technique for model enhancement in supervised learning with potential applications to a variety of imaging tasks, such as segmentation, registration, and recognition. In particular, the present invention has shown potential in medical image enhancement.

### BACKGROUND

Medical imaging is the technique and process of imaging the interior of a body for clinical analysis and medical intervention, as well as visual representation of the function of some organs or tissues (physiology). Medical imaging seeks to reveal internal structures hidden by the skin and bones, as well as to diagnose and treat diseases.

Advances in both imaging and machine learning have synergistically led to a rapid rise in the potential use of artificial intelligence in various medical imaging tasks, such as risk assessment, detection, diagnosis, prognosis, and therapy response.

Nowadays, as shown by the following examples, machine learning is used not only for classification of images or detection of symptoms, but also for the generation of synthetic images.

WO2019/074938A1 discloses a method and a system for performing diagnostic imaging of a subject with reduced contrast agent dose. In a first step, a set of diagnostic images of a set of subjects is produced. The set of images comprises, for each subject of the set of subjects, i) a full-contrast image acquired with a full contrast agent dose administered to the subject, ii) a low-contrast image acquired with a low contrast agent dose administered to the subject, where the low contrast agent dose is less than the full contrast agent dose, and iii) a zero-contrast image acquired with no contrast agent dose administered to the subject. In a second step, a deep learning network (DLN) is trained by applying zero-contrast images from the set of images and low-contrast images from the set of images as input to the DLN and using a loss function to compare the output of the DLN with full-contrast images from the set of images to train parameters of the DLN using backpropagation. Once the DLN is trained, it can be used to generate a synthetic full-contrast contrast agent image of a subject by applying a low-contrast image and a zero-contrast image as input to the trained DLN. When comparing a synthetic full-contrast image generated in accordance with the method described in WO2019/074938A1 with the respective real full-contrast image (the reference ground truth image), deviations can be observed.

WO2018/048507A1 discloses a method for generating synthetic CT images (CT: computed tomography) from original MRI images (MRI: magnetic resonance imaging) using a trained convolutional neural network. When comparing the synthetic CT image generated in accordance with the method described in WO2018/048507A1 with the respective real CT image (the reference ground truth image), deviations can be observed.

WO2017/091833 discloses a method for automated segmentation of anatomical structures, such as the human heart, represented by image data, such as 3D MRI data. A convolutional neural network is trained on the basis of labeled images to autonomously segment various parts of an anatomical structure. Once trained, the convolutional neural network receives an image as input and generates as an output a segmented image in which certain anatomical structures are masked. When comparing the segmented image (a synthetic image) generated in accordance with the method described in WO2017/091833 with the respective image masked by a medical expert, deviations can be observed.

The technical problem to be solved is to improve the quality of synthetic images. In this context, quality is characterized by the ability of the models to learn small details that have very little impact on global error metrics but bring significant clinical value, such as small structures (e.g., small veins and lesions), as well accurate boundary delineations.

### SUMMARY

The described problem is solved by the subject matter of the independent claims of the present invention. Preferred embodiments of the present invention are defined in the dependent claims and described in the present specification and/or displayed in the figures.

The present invention provides, in a first aspect, a method of training a predictive machine learning model to generate a synthetic image. In some embodiments, the method comprises:
providing an actor-critic framework comprising an actor and a critic, and
training the actor critic framework based on training data comprising a multitude of datasets, each dataset comprising i) an input dataset and ii) a corresponding ground truth image,
   wherein the actor is trained to:
      generate, for each dataset, at least one synthetic image from the input dataset,
   wherein the critic is trained to:
      receive the at least one synthetic image and/or the corresponding ground truth image,
      classify the received image(s) into one of two classes, a first class and a second class, the first class comprising synthetic images, and the second class comprising ground truth images, and
      output a classification result,
   wherein a saliency map relating to the received image(s) is generated from the critic based on the classification result, and
   wherein a loss function is used to minimize deviations between the at least one synthetic image and the corresponding ground truth image at least partially on the basis of the saliency map.

In a further aspect, the present invention provides a computer system for training a predictive machine learning model to generate a synthetic image. In some embodiments, the computer system comprises:
a receiving unit,
a processing unit, and
an output unit
   wherein the processing unit is configured to:
receive training data via the receiving unit, the training data comprising a multitude of datasets, each dataset comprising i) an input dataset and ii) a corresponding ground truth image,
provide an actor-critic framework comprising an actor and a critic, and
train the actor critic framework based on the training data,
   wherein the actor is trained to:
      generate, for each dataset, at least one synthetic image from the input dataset,
   wherein the critic is trained to:
      receive the at least one synthetic image and/or the corresponding ground truth image,
      classify the received image(s) into one of two classes, a first class and a second class, the first class comprising synthetic images, and the second class comprising ground truth images, and
      output a classification result,
   wherein a saliency map relating to the received image(s) is generated from the critic based on the classification result, and
   wherein a loss function is used to minimize deviations between the at least one synthetic image and the corresponding ground truth image at least partially on the basis of the saliency map.

In a further aspect, the present invention provides a non-transitory computer-readable storage medium storing instructions to perform an operation for training a predictive machine learning model to generate a synthetic image that, when executed by one or more processors of an electronic device, cause the device to:
provide an actor-critic framework comprising an actor and a critic, and
train the actor-critic framework based on training data a multitude of datasets, each dataset comprising i) an input dataset and ii) a corresponding ground truth image,
   wherein the actor is trained to:
      generate, for each dataset, at least one synthetic image from the input dataset,
   wherein the critic is trained to:
      receive the at least one synthetic image and/or the corresponding ground truth image,
      classify the received image(s) into one of two classes, a first class and a second class, the first class comprising synthetic images, and the second class comprising ground truth images, and
      output a classification result,
   wherein a saliency map relating to the received image(s) is generated from the critic based on the classification result, and
   wherein a loss function is used to minimize deviations between the at least one synthetic image and the corresponding ground truth image at least partially on the basis of the saliency map.

In a further aspect, the present invention provides a method of generating a synthetic image, the method comprising:
receiving an input dataset,
inputting the input dataset into a predictive machine learning model,
receiving from the predictive machine learning model the synthetic image, and
outputting the synthetic image,
   wherein the predictive machine learning model was trained in a training process to generate synthetic images from input datasets, the training process comprising:
receiving training data comprising a multitude of datasets, each dataset comprising i) an input dataset and ii) a corresponding ground truth image,
providing an actor-critic framework comprising an actor and a critic, and
training the actor-critic framework based on the training data,
   wherein the actor is trained to:
      generate, for each dataset, at least one synthetic image from the input dataset, and
      output the at least one synthetic image,
   wherein the critic is trained to:
      receive the at least one synthetic image and/or the corresponding ground truth image,
      output a classification result for each received image, wherein the classification result indicates whether the received image is a synthetic image or a ground truth image,
   wherein a saliency map relating to the received image(s) is generated from the critic based on the classification result, and
   wherein a loss function is used to minimize deviations between the at least one synthetic image and the corresponding ground truth image at least partially on the basis of the saliency map.

In a further aspect, the present invention provides a computer system for generating a synthetic image, the computer system comprising:
a receiving unit,
a processing unit, and
an output unit,
   wherein the processing unit is configured to:
receive, via the receiving unit, an input dataset,
input the input dataset into a predictive machine learning model,
receive from the predictive machine learning model a synthetic image, and
output the synthetic image via the output unit,
   wherein the predictive machine learning model was trained in a training process to generate synthetic images from input datasets, wherein the training process comprises:
receiving training data comprising a multitude of datasets, each dataset comprising i) an input dataset and ii) a corresponding ground truth image,
providing an actor-critic framework comprising an actor and a critic,
training the actor-critic framework based on the training data,
   wherein the actor is trained to:
      generate, for each dataset, at least one synthetic image from the input dataset, and
      output the at least one synthetic image,
   wherein the critic is trained to:
      receive the at least one synthetic image and/or the corresponding ground truth image, and
      output a classification result for each received image, wherein the classification result indicates whether the received image is a synthetic image or a ground truth image,
   wherein a saliency map relating to the received image(s) is generated from the critic based on the classification result, and
   wherein a loss function is used to minimize deviations between the at least one synthetic image and the corresponding ground truth image at least partially on the basis of the saliency map.

In a further aspect, the present invention provides a non-transitory computer-readable storage medium storing instructions with for generating a synthetic image that, when executed by one or more processors of an electronic device, cause the device to:
receive an input dataset,
input the input dataset into a predictive machine learning model,
receive from the predictive machine learning model the synthetic image, and
output the synthetic image,
   wherein the predictive machine learning model was trained in a training process to generate synthetic images from input datasets, wherein the training process comprises:
receiving training data comprising a multitude of datasets, each dataset comprising i) an input dataset and ii) a corresponding ground truth image,
providing an actor-critic framework comprising an actor and a critic, and
training the actor-critic framework based on the training data,
   wherein the actor is trained to:
      generate, for each dataset, at least one synthetic image from the input dataset, and
      output the at least one synthetic image,
   wherein the critic is trained to:
      receive the at least one synthetic image and/or the corresponding ground truth image, and
      output a classification result for each received image, wherein the classification result indicates whether the received image is a synthetic image or a ground truth image,
   wherein a saliency map relating to the received image(s) is generated from the critic based on the classification result, and
   wherein a loss function is used to minimize deviations between the at least one synthetic image and the corresponding ground truth image at least partially on the basis of the saliency map.

### BRIEF DESCRIPTION OF THE FIGURES

The invention will now be described, by way of example only, with reference to the accompanying drawings.

FIG. 1 shows a neural network system, according to some embodiments.

FIG. 2 shows a predictive machine learning model for generating a synthetic image from (new) input data, according to some embodiments.

FIG. 3 shows a comparison between a prediction obtained without actor-critic (AC) training and a prediction obtained with actor-critic training, according to some embodiments.

FIG. 4 shows a computer system, according to some embodiments.

FIG. 5 shows an embodiment of a method according to the present invention.

FIG. 6 shows another embodiment of a method according to the present invention.

FIG. 7 shows another embodiment of a method according to the present invention.

FIG. 8 shows another embodiment of a method according to the present invention.

### DETAILED DESCRIPTION

The invention will be more particularly elucidated below without distinguishing between the aspects of the invention (methods, computer systems, computer-readable storage media). On the contrary, the following elucidations are intended to apply analogously to all the aspects of the invention, irrespective of in which context (methods, computer systems, computer-readable storage media) they occur.

If steps are stated in an order in the present description or in the claims, this does not necessarily mean that the invention is restricted to the stated order. On the contrary, it is conceivable that the steps can also be executed in a different order or else in parallel to one another, unless one step builds upon another step, this absolutely requiring that the building step be executed subsequently (this being, however, clear in the individual case). The stated orders are thus preferred embodiments of the invention.

As used herein, the articles “a” and “an” are intended to include one or more items, and may be used interchangeably with “one or more” and “at least one.” As used in the specification and the claims, the singular form of “a,” “an,” and “the” include plural referents, such as unless the context clearly dictates otherwise. Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Further, the phrase “based on” may mean “in response to” and be indicative of a condition for automatically triggering a specified operation of an electronic device (e.g., a controller, a processor, a computing device, etc.) as appropriately referred to herein.

The present invention provides a training protocol for training a predictive machine learning model to generate synthetic images on the basis of an input dataset.

The term “image” as used herein means a data structure that represents a spatial distribution of a physical signal. The spatial distribution may be of any dimension, for example 2D, 3D, 4D or any higher dimension. The spatial distribution may be of any shape, for example forming a grid and thereby defining pixels, the grid being possibly irregular or regular. The physical signal may be any signal, for example proton density, tissue echogenicity, tissue radiolucency, measurements related to the blood flow, information of rotating hydrogen nuclei in a magnetic field, color, level of gray, depth, surface or volume occupancy, such that the image may be a 2D or 3D RGB/grayscale/depth image, or a 3D surface/volume occupancy model.

An image is usually a representation of an object. The object can be a real object such as a person and/or an animal and/or a plant and/or an inanimate object and/or a part thereof, and/or combinations thereof. The object can also be an artificial and/or virtual object such as a construction drawing.

In a preferred embodiment, an image is a two- or three- or higher-dimensional representation of a human body or a part thereof. Preferably, an image is a medical image showing a part of the body of a human, such as an image created by one or more of the following techniques: microscopy, X-ray radiography, magnetic resonance imaging, computed tomography, ultrasound, endoscopy, elastography, tactile imaging, thermography, medical photography, nuclear medicine functional imaging techniques as positron emission tomography (PET) and single-photon emission computed tomography (SPECT), optical coherence tomography and the like.

Examples of medical images include CT (computer tomography) scans, X-ray images, MRI (magnetic resonance imaging) scans, fluorescein angiography images, OCT (optical coherence tomography) scans, histopathological images, ultrasound images and others.

An image according to the present invention is a digital image. A digital image is a numeric representation, normally binary, of an image of two or more dimensions. A digital image can be a greyscale image or color image in RGB format or another color format, or a multispectral or hyperspectral image. A widely used format for digital medical images is the DICOM format (DICOM: Digital Imaging and Communications in Medicine).

A synthetic image is an image which is generated (calculated) from an input dataset.

The input dataset from which the synthetic image is generated can be any data from which an image can be generated. In a preferred embodiment, the input dataset is or comprises an image. So, for example, the synthetic image can, e.g., be generated from one or more (other) image(s).

The synthetic image can, e.g., be a segmented image generated from an original (unsegmented) image (see, e.g., WO2017/091833).

The synthetic image can, e.g., be a synthetic CT images generated from an original MRI image (see, e.g., WO2018/048507A1).

The synthetic image can, e.g., be a synthetic full-contrast image generated from a zero-contrast image and a low-contrast image (see, e.g., WO2019/074938A1). In this case the input dataset comprises two images, a zero-contrast image and a low-contrast image.

It is also possible that the synthetic image is generated from one or more images in combination with further data such as data about the object which is represented by the one or more images. It is also possible that the synthetic image is created from an input dataset which usually is not considered as an image, such as, e.g., the reconstruction of a magnetic resonance image from k-space data (see, e.g., US20200202586A1, US20210166351A1). In this case the synthetic image is a magnetic resonance image and the input dataset comprises k-space data.

Further examples are conceivable.

The synthetic image is generated from the input dataset using a predictive machine learning model. The predictive machine learning model is configured to receive the input dataset and calculates from the input dataset the synthetic image and outputs the synthetic image. It is also possible that more than one synthetic image is generated from the input dataset by the predictive machine learning model.

The term “predictive” indicates that predictive machine learning model is intended to predict (generate, calculate) synthetic images.

Such a machine learning model may be understood as a computer implemented data processing architecture. The machine learning model can receive input data and provide output data based on that input data and the machine learning model, in particular the parameters of the machine learning model. The machine learning model can learn a relation between input data and output data through training. In training, parameters of the machine learning model may be adjusted in order to provide a desired output for a given input.

The process of training a machine learning model involves providing a machine learning algorithm (that is the learning algorithm) with training data to learn from. The term machine learning model refers to the model artifact that is created by the training process. The training data must contain the correct answer, which is referred to as the target. The learning algorithm finds patterns in the training data that map input data to the target, and it outputs a trained machine learning model that captures these patterns.

In the training process, training data are input into the machine learning model and the machine learning model generates an output. The output is compared with the (known) target. Parameters of the machine learning model are modified in order to reduce the deviations between the output and the (known) target to a (defined) minimum.

In general, a loss function can be used for training to evaluate the machine learning model. For example, a loss function can include a metric of comparison of the output and the target. The loss function may be chosen in such a way that it rewards a wanted relation between output and target and/or penalizes an unwanted relation between an output and a target. Such a relation can be, e.g., a similarity, or a dissimilarity, or another relation.

A loss function can be used to calculate a loss value for a given pair of output and target. The aim of the training process can be to modify (adjust) parameters of the machine learning model in order to reduce the loss value to a (defined) minimum.

A loss function may, for example, quantify the deviation between the output of the machine learning model for a given input and the target. If, for example, the output and the target are numbers, the loss function could be the difference between these numbers, or alternatively the absolute value of the difference. In this case, a high absolute value of the loss function may indicate that a parameter of the model needs to undergo a strong change.

In the case of a scalar output, a loss function may be a difference metric such as an absolute value of a difference or a squared difference.

In the case of vector-valued outputs, for example, difference metrics between vectors such as the root mean square error, a cosine distance, a norm of the difference vector such as a Euclidean distance, a Chebyshev distance, an Lp-norm of a difference vector, a weighted norm, or any other type of difference metric of two vectors can be chosen. These two vectors may, for example, be the desired output (target) and the actual output.

In the case of higher dimensional outputs, such as two-dimensional, three-dimensional or higher-dimensional outputs, for example, an element-wise difference metric may for example be used. Alternatively or additionally, the output data may be transformed, for example to a one-dimensional vector, before computing a loss value.

The predictive machine learning model is trained to generate at least one synthetic image from an input dataset. The training can be performed, e.g., in a supervised learning with a set of training data comprising a multitude of datasets, each dataset comprising i) an input dataset and ii) a corresponding ground truth image.

The term “multitude” as it is used herein means an integer greater than 1, usually greater than 10, preferably greater than 100.

In case of the generation of synthetic medical images, the training data usually comprises datasets from a multitude of subjects (e.g., patients). For each subject, the dataset comprises an input dataset and a ground truth image. If the input dataset and a ground truth image belong to the same subject, such a pair of input dataset and ground truth image is referred to as “corresponding to each other”: the input dataset of a subject corresponds to the ground truth image of the same subject and the ground truth image of a subject corresponds to the input dataset of the same subject.

The “ground truth image” is the image, the synthetic image generated by the predictive machine learning model should look like if the predictive machine learning model is fed by the respective input dataset. The aim is to train the predictive machine learning model to generate for each pair of a ground truth image and an input dataset a synthetic image which comes close to the ground truth image (ideally, the synthetic image matches the ground truth image).

In case of the present invention, the training is done using an actor-critic (AC) framework. Such an actor-critic (AC) framework comprises two machine learning models which are connected to each other: an actor and a critic. The actor is configured to receive an input dataset and to predict a synthetic image from the input dataset as output. The critic is configured to assess the result of the actor and to give the actor indications as to which areas in the synthetic image still differ from the respective ground truth image.

Thus, in addition to the actor (the model which is responsible for generating the synthetic image), a second machine learning model (the critic) is used to identify regions in images which distinguish synthetic images from ground truth images. In other words, the actor is trained to predict a synthetic image from input data whereas the critic is trained to check how accurate the prediction is.

The critic can be configured as a classifier. In general, a classifier is any algorithm that sorts data into labeled classes, or categories of information. In case of the present invention, the classifier (the critic) is trained to classify an incoming image into one of two classes, a first class and a second class. The first class comprises synthetic images, and the second class comprises ground truth images.

In other words, the critic determines whether an incoming image is a synthetic image or a ground truth image.

In other words, the critic is trained to receive a synthetic image and/or the corresponding ground truth image, and classify the received image(s) into one of two classes, a first class and a second class. The first class comprises synthetic images, and the second class comprises ground truth images. The classification result, i.e. the information whether the received image is a synthetic image or a ground truth image can be outputted by the critic.

The classification result can be used to generate a saliency map for the received image.

A saliency map shows which parts of an input image are most relevant for the critic in order to decide which class the image belongs to. In other words, a saliency map shows what the classifier is looking at when doing the classification. The salience map can, e.g., be an image which has the same dimensions as the received image (the image input into the critic) and in which areas can be identified which caused the classifier to place the original image in one of the classes.

A saliency map can be generated for a synthetic image and/or for the corresponding ground truth image and/or for a pair comprising of a synthetic image and the corresponding ground truth image.

The saliency map can, e.g., be created by taking the gradient of the output of the critic with respect to the input image. Various manipulations of the gradient maps are possible, e.g., using only positive part or taking the absolute values.

In a preferred embodiment of the present invention, gradient maps from a synthetic image and from the corresponding ground truth image are created. Absolute values from both gradient maps the absolute values are taken and the mean (e.g., arithmetic mean) of the saliency maps of the ground truth image and the synthetic image is computed, rescaled to a predefined number, and a A positive constant is added for stabilization.

However, other possibilities to compute and combine saliency maps will fit in the proposed framework.

More details about saliency maps may be found in various publications related thereto (e.g., D. Erhan et al.: Visualizing Higher-Layer Features of a Deep Network, Technical Report, 2009, Université de Montréal; https://arxiv.org/pdf/1312.6034.pdf; https://arxiv.org/pdf/1705.07857.pdf; https://arxiv.org/pdf/1911.11293.pdf; https://doi.org/10.1016/j.cviu.2018.03.005; https://doi.org/10.1016/j.patcog.2019.05.002).

The saliency map(s) is/are used to guide the training of the actor to the regions highlighted by the critic. In other words, a loss function can be computed at least partially on the basis of the saliency map, the loss function quantifying the deviations between a synthetic image and the corresponding ground truth image, in particular in the areas identified in the saliency map(s).

This can be achieved, e.g., by multiplying a pixel-wise loss function with the saliency map(s), hence weighting the actor's loss at every pixel of the image by the importance assigned to this pixel in the saliency map of the critic. As a consequence, the actor focuses on these specific regions that are critical in distinguishing the ground truth image from the synthetic image. The loss function augmented by the saliency map can be chosen freely. Preferably the loss function is defined on a per-pixel basis. Examples include L1 loss, L2 loss, or combination thereof. More details about loss functions may be found in the scientific literature (see, e.g., K. Janocha et al.: On Loss Functions for Deep Neural Networks in Classification, 2017, arXiv: 1702.05659v1 [cs.LG]; H. Zhao et al.: Loss Functions for Image Restoration with Neural Networks, 2018, arXiv: 1511.08861v3 [cs.CV]).

The aim of the training is to minimize the loss computed using the loss function. Once a defined minimum of the loss (a pre-defined accuracy of the actor in generating synthetic images) is achieved the trained actor-critic framework can be stored on a data storage and/or (directly) used for predicting a (new) synthetic image on the basis of a (new) input dataset.

For prediction purposes, the critic can be discarded. Usually, the critic is only used for training purposes. The trained actor constitutes a predictive machine learning model for generating synthetic images on the basis of input datasets.

In one embodiment of the present invention, the predictive machine learning model is trained and used to generate a segmented image form an original (unsegmented) image, wherein manually segmented and unsegmented images can be used for training.

In another embodiment of the present invention, the predictive machine learning model is trained and used to generate a synthetic CT image from an original MRI image, wherein original CT images and original MRT images can be used for training.

In another embodiment of the present invention, the predictive machine learning model is trained and used to generate a synthetic full-contrast image from a zero-contrast image and a low-contrast image, wherein real full-contrast images as well as zero-contrast images and low-contrast images can be used for training. The images can comprise, e.g., CT scans or MRI scans. The contrast agent can comprise, e.g., a contrast agent used in CT (such as iodine-containing solutions) or used in MRI (such as a gadolinium chelate).

In another embodiment of the present invention, the predictive machine learning model is trained and used to reconstruct an MRI image from k-space data, wherein k-space data and MRI images conventionally reconstructed from the k-space data can be used for training.

The actor can be an artificial neural network. An artificial neural network (ANN) is a biologically inspired computational model. An ANN usually comprises at least three layers of processing elements: a first layer with input neurons (nodes), an N-th layer with at least one output neuron (node), and N−2 inner layers, where N is a natural number greater than 2.

In such a network, the input neurons serve to receive the input dataset. If the input dataset constitutes or comprises an image, there is usually one input neuron for each pixel/voxel of the input image; there can be additional input neurons for additional input data such as data about the object represented by the input image. The output neurons serve to output at least one synthetic image. Usually, there is one output neuron for each pixel/voxel of the synthetic image.

The processing elements of the layers are interconnected in a predetermined pattern with predetermined connection weights therebetween. Each network node usually represents a (simple) calculation of the weighted sum of inputs from prior nodes and a non-linear output function. The combined calculation of the network nodes relates the inputs to the outputs.

When trained, the connection weights between the processing elements in the ANN contain information regarding the relationship between the input dataset and the ground truth images which can be used to predict synthetic images from a new input dataset.

The actor neural network can be configured to receive an input dataset and to predict a synthetic image from the input dataset as output.

The actor neural network can employ any image-to-image neural network architecture; for example, the actor neural network can be of the class of convolutional neural networks (CNN).

A CNN is a class of deep neural networks, most commonly applied to analyzing visual imagery. A CNN comprises an input layer with input neurons, an output layer with at least one output neuron, as well as multiple hidden layers between the input layer and the output layer.

The hidden layers of a CNN typically comprise convolutional layers, ReLU (Rectified Linear Units) layers (i.e., activation function layers), pooling layers, fully connected layers, and normalization layers.

The nodes in the CNN input layer can be organized into a set of “filters” (feature detectors), and the output of each set of filters is propagated to nodes in successive layers of the network. The computations for a CNN include applying the mathematical convolution operation with each filter to produce the output of that filter. Convolution is a specialized kind of mathematical operation performed with two functions to produce a third function. In convolutional network terminology, the first function of the convolution can be referred to as the input, while the second function can be referred to as the convolution kernel. The output may be referred to as the feature map. For example, the input of a convolution layer can be a multidimensional array of data that defines the various color components of an input image. The convolution kernel can be a multidimensional array of parameters, where the parameters are adapted by the training process for the neural network.

The objective of the convolution operation is to extract features (such as, e.g., edges from an input image). Conventionally, the first convolutional layer is responsible for capturing the low-level features such as edges, color, gradient orientation, etc. With added layers, the architecture adapts to the high-level features as well, giving a network which has the wholesome understanding of images in the dataset. Similar to the convolutional layer, the pooling layer is responsible for reducing the spatial size of the feature maps. It is useful for extracting dominant features with some degree of rotational and positional invariance, thus maintaining the process of effectively training of the model. Adding a fully-connected layer is a way of learning non-linear combinations of the high-level features as represented by the output of the convolutional part.

In a preferred embodiment of the present invention, the actor neural network is based on a specific kind of convolutional architecture called U-Net (see, e.g., O. Ronneberger et al.: U-net: Convolutional networks for biomedical image segmentation, in: International Conference on Medical image computing and computer-assisted intervention, pp. 234-241, Springer, 2015, https://doi.org/10.1007/978-3-319-24574-4_28). The U-Net architecture consists of two main blocks, an encoding path and a decoding path. The encoding path uses convolutions, activation functions and pooling layers to extract image features, while the decoding path replaces the pooling layers with upsampling layers to project the extracted features back to pixel/voxel space, and finally recovers the image dimension at the end of the architecture. These are used in combination with activation functions and convolutions. Finally, the feature maps from the encoding paths can be concatenated to the feature maps in the decoding path in order to preserve fine details from the input data.

More details about how to implement a convolutional neural network can be found in the literature (see, e.g., Yu Han Liu: Feature Extraction and Image Recognition with Convolutional Neural Networks, 2018, J. Phys.: Conf. Ser. 1087 062032; H. H. Aghdam et al.: Guide to Convolutional Neural Networks, Springer 2017, ISBN: 978-3-319-57549-0; S. Khan et al.: Convolutional Neural Networks for Computer Vision, Morgan & Claypool Publishers, 2018, ISBN: 978-1-681-730219). The critic can be or comprise an artificial neural network, as well.

In a preferred embodiment, the critic neural network is or comprises a convolutional neural network. Therefore, the critic neural network preferably uses the same building blocks as described above, such as convolutional layers, activation functions, pooling layers and fully connected layers.

In the actor-critic neural network system of the present invention, the actor neural network and the critic neural network are interconnected. A synthetic image which is generated by the actor neural network can be input into the critic neural network. In addition, the ground truth images which are used for the training of the actor neural network can be input into the critic neural network as well. So, for each dataset of the training data, the input dataset is fed into the actor neural network, a synthetic image is generated from the input dataset by the actor neural network, and the synthetic image is compared with the corresponding ground truth image. In addition, the synthetic image and/or the corresponding ground truth image are fed into the critic neural network. The critic neural network is trained to recognize whether the inputted image is a synthetic image or a ground truth image.

From the critic neural network, a saliency map can be generated for each inputted image.

The saliency map(s) is/are used to guide the training of the actor to the regions highlighted by the critic.

Preferably, the neural network system of the present invention is trained to perform the two tasks, namely the prediction of synthetic images and the classification of images, simultaneously. For the combined learning of performing the two tasks, a combined loss function is computed. The loss function is computed on the basis of the synthetic image, the ground truth image, the classification result and the saliency map.

It is possible to pre-train the actor neural network and/or the critic neural network to perform their respective task separately, before both networks are combined in the neural network system according to the present invention and are trained together as described herein.

In the main algorithm, training of the actor and critic networks can be alternated, with each one being trained iteratively to incorporate the training progress in the other, until convergence of the actor/critic system to a minimum.

For training and/or pre-training, a cross-validation method can be employed to split the training data into a training data set and a validation data set. The training data set is used in the backpropagation training of the network weights. The validation data set is used to verify that the trained network generalizes to make good predictions. The best network weight set can be taken as the one that best predicts the outputs of the training data. Similarly, varying the number of network hidden nodes and determining the network that performs best with the data sets optimizes the number of hidden nodes.

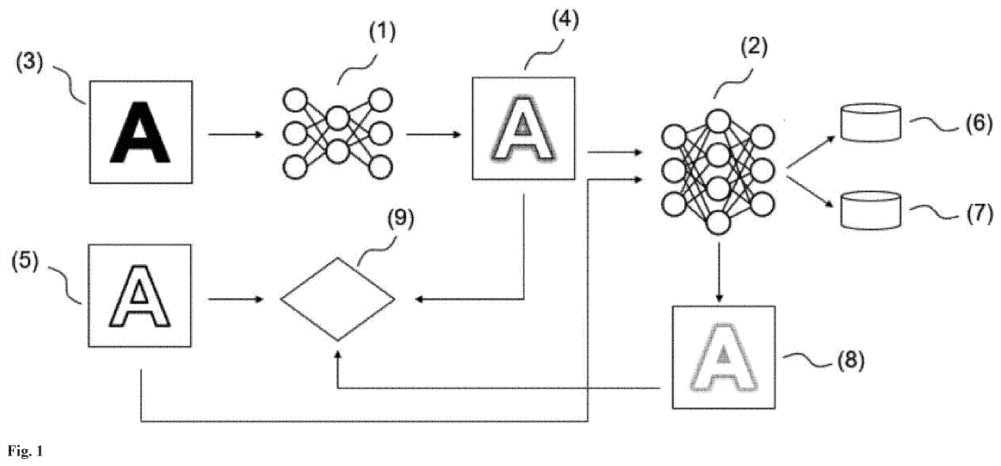

FIG. 1 shows schematically by way of example one preferred embodiment of the neural network system according to the present invention. The neural network system comprises a first neural network (1) and a second neural network (2). The first neural network (1) is referred herein as the actor neural network. The second neural network (2) is referred herein as the critic neural network.

The first neural network (1) is configured to receive an input dataset (3). In case of the example depicted in FIG. 1, the input dataset (3) constitutes a digital image. The first neural network (1) is trained to generate a synthetic image (4) from the input dataset (3) which comes close to a ground truth image (5). Ideally, the synthetic image (4) matches the ground truth image (5). In case of the example as depicted in FIG. 1, the synthetic image (4) deviates from the ground truth image (5). In order to limit the deviations, the second neural network (2) is configured to receive the synthetic image (4) as well as the ground truth image (5), and it is trained to classify the received images into one of two classes, a first class (6) and a second class (7). The first class (6) comprises synthetic images, the second class (7) comprises ground truth images. From the second neural network (2) a saliency map (8) is generated on the basis of the classification result (for each inputted image and/or for each pair of a synthetic image and a ground truth image). Such a salience map (8) highlights the regions in an image (4, 5), the classification of the image (4, 5) in one of the two classes is mainly based on. This information can be used to improve the accuracy of the prediction of the synthetic image (4) done by the first neural network (1). A loss function (9) is used for a combined training of the first neural network (1) and the second neural network (2). The aim of the loss function (9) is to minimize the deviations between the synthetic image (4) and the ground truth image (5) on the basis of the synthetic image (4), the ground truth image (5) and the saliency map(s) (8).

Once trained, the critic can be discarded and the actor can be used as predictive machine learning model to generate synthetic images on the basis of new input data.

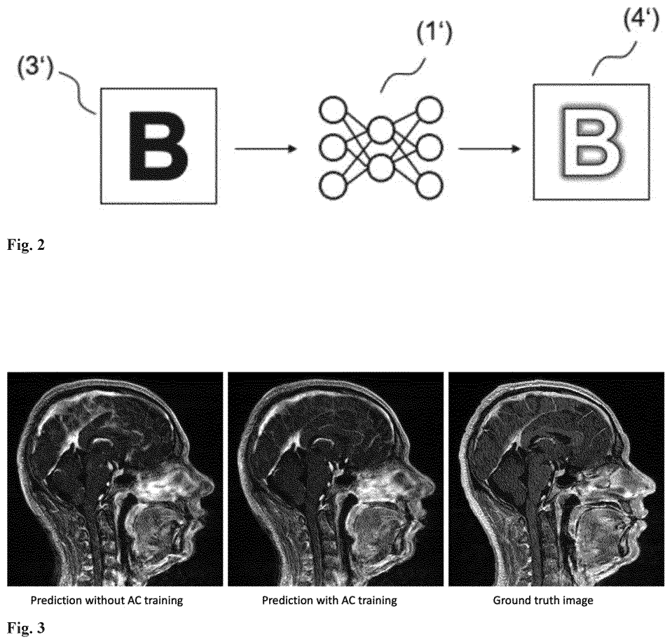

FIG. 2 shows schematically by way of example a predictive machine learning model which is used for generating a synthetic image from (new) input data.

The predictive machine learning model (1′) is or comprises the first neural network (1) of FIG. 1 which was trained as described for FIG. 1. The predictive machine learning model (1′) receives a (new) input dataset (3′) and generates a synthetic image (4′) from the (new) input dataset (3′).

The synthetic image (4′) can then be outputted, e.g., displayed on a monitor, printed on a printer and/or stored in a data storage.

FIG. 3 shows a comparison between a prediction obtained without AC training (left), i.e., actor network only, and a prediction obtained with AC training (middle), as well as the corresponding ground truth image (right). The AC training (the training according to the present invention) allows to refine the small details that are missing or blurred in the actor only prediction.

The operations in accordance with the teachings herein may be performed by at least one computer specially constructed for the desired purposes or general-purpose computer specially configured for the desired purpose by at least one computer program stored in a typically non-transitory computer readable storage medium.

The term “non-transitory” is used herein to exclude transitory, propagating signals or waves, but to otherwise include any volatile or non-volatile computer memory technology suitable to the application.

The term “computer” should be broadly construed to cover any kind of electronic device with data processing capabilities, including, by way of non-limiting example, personal computers, servers, embedded cores, computing system, communication devices, processors (e.g., digital signal processor (DSP), microcontrollers, field programmable gate array (FPGA), application specific integrated circuit (ASIC), etc.) and other electronic computing devices.

The term “process” as used herein is intended to include any type of computation or manipulation or transformation of data represented as physical, e.g., electronic, phenomena which may occur or reside, e.g., within registers and/or memories of at least one computer or processor. The term processor includes a single processing unit or a plurality of distributed or remote such units.

Any suitable input device, such as but not limited to a keyboard, a mouse, a microphone and/or a camera sensor, may be used to generate or otherwise provide information received by the system and methods shown and described herein. Any suitable output device or display, such as but not limited to a computer screen (monitor) and/or printer may be used to display or output information generated by the system and methods shown and described herein. Any suitable processor/s, such as bot not limited to a CPU, DSP, FPGA and/or ASIC, may be employed to compute or generate information as described herein and/or to perform functionalities described herein. Any suitable computerized data storage, such as but not limited to optical disks, CDROMs, DVDs, BluRays, magnetic-optical discs or other discs;

RAMs, ROMs, EPROMs, EEPROMs, magnetic or optical or other cards, may be used to store information received by or generated by the systems shown and described herein. Functionalities shown and described herein may be divided between a server computer and a plurality of client computers. These or any other computerized components shown and described herein may communicate between themselves via a suitable computer network.

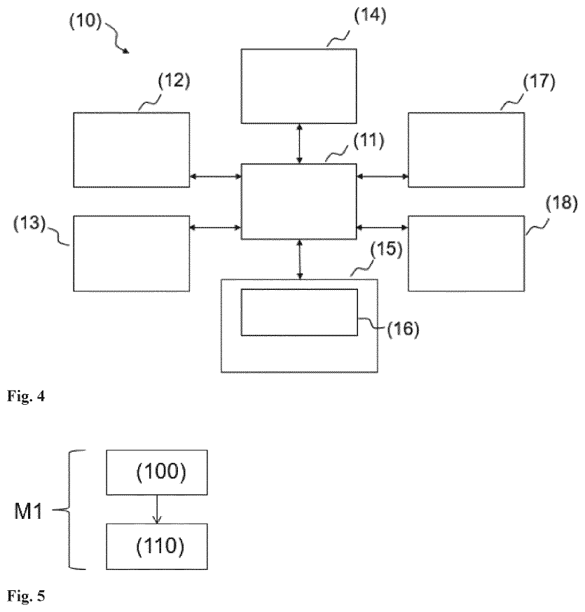

FIG. 4 illustrates a computer system (10) according to some example implementations of the present invention in more detail. Generally, a computer system of exemplary implementations of the present disclosure may be referred to as a computer and may comprise, include, or be embodied in one or more fixed or portable electronic devices. The computer may include one or more of each of a number of components such as, for example, processing unit (11) connected to a memory (15) (e.g., storage device).

The processing unit (11) may be composed of one or more processors alone or in combination with one or more memories. The processing unit is generally any piece of computer hardware that is capable of processing information such as, for example, data (incl. digital images), computer programs and/or other suitable electronic information. The processing unit is composed of a collection of electronic circuits some of which may be packaged as an integrated circuit or multiple interconnected integrated circuits (an integrated circuit at times more commonly referred to as a “chip”). The processing unit (11) may be configured to execute computer programs, which may be stored onboard the processing unit or otherwise stored in the memory (15) of the same or another computer.

The processing unit (11) may be a number of processors, a multi-core processor or some other type of processor, depending on the particular implementation. Further, the processing unit may be implemented using a number of heterogeneous processor systems in which a main processor is present with one or more secondary processors on a single chip. As another illustrative example, the processing unit may be a symmetric multi-processor system containing multiple processors of the same type. In yet another example, the processing unit may be embodied as or otherwise include one or more ASICs, FPGAs or the like. Thus, although the processing unit may be capable of executing a computer program to perform one or more functions, the processing unit of various examples may be capable of performing one or more functions without the aid of a computer program. In either instance, the processing unit may be appropriately programmed to perform functions or operations according to example implementations of the present disclosure.

The memory (15) is generally any piece of computer hardware that is capable of storing information such as, for example, data, computer programs (e.g., computer-readable program code (16)) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disk-read only memory (CD-ROM), compact disk-read/write (CD-R/W), DVD, Blu-ray disk or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

In addition to the memory (15), the processing unit (11) may also be connected to one or more interfaces (12, 13, 14, 17, 18) for displaying, transmitting and/or receiving information. The interfaces may include one or more communications interfaces (17, 18) and/or one or more user interfaces (12, 13, 14). The communications interface(s) may be configured to transmit and/or receive information, such as to and/or from other computer(s), network(s), database(s) or the like. The communications interface may be configured to transmit and/or receive information by physical (wired) and/or wireless communications links. The communications interface(s) may include interface(s) to connect to a network, such as using technologies such as cellular telephone, Wi-Fi, satellite, cable, digital subscriber line (DSL), fiber optics and the like. In some examples, the communications interface(s) may include one or more short-range communications interfaces configured to connect devices using short-range communications technologies such as NFC, RFID, Bluetooth, Bluetooth LE, ZigBee, infrared (e.g., IrDA) or the like.

The user interfaces (12, 13, 14) may include a display (14). The display (14) may be configured to present or otherwise display information to a user, suitable examples of which include a liquid crystal display (LCD), light-emitting diode display (LED), plasma display panel (PDP) or the like. The user input interface(s) (12, 13) may be wired or wireless, and may be configured to receive information from a user into the computer system (10), such as for processing, storage and/or display. Suitable examples of user input interfaces include a microphone, image or video capture device, keyboard or keypad, joystick, touch-sensitive surface (separate from or integrated into a touchscreen) or the like. In some examples, the user interfaces may include automatic identification and data capture (AIDC) technology for machine-readable information. This may include barcode, radio frequency identification (RFID), magnetic stripes, optical character recognition (OCR), integrated circuit card (ICC), and the like. The user interfaces may further include one or more interfaces for communicating with peripherals such as printers and the like.

As indicated above, program code instructions may be stored in memory, and executed by processing unit that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, processing unit or other programmable apparatus to function in a particular manner to thereby generate a particular machine or particular article of manufacture. The program code instructions may be retrieved from a computer-readable storage medium and loaded into a computer, processing unit or other programmable apparatus to configure the computer, processing unit or other programmable apparatus to execute operations to be performed on or by the computer, processing unit or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

FIG. 5 shows schematically and exemplarily an embodiment of the method according to the present invention in the form of a flow chart. The method M1 comprises the steps:
(100) providing an actor-critic framework comprising an actor and a critic,
(110) training the actor-critic framework based on training data comprising a multitude of datasets, each dataset comprising i) an input dataset and ii) a corresponding ground truth image,
   wherein the actor is trained to:
      generate, for each dataset, at least one synthetic image from the input dataset,
   wherein the critic is trained to:
      receive the at least one synthetic image and/or the corresponding ground truth image, and
      classify the received image(s) into one of two classes, a first class and a second class, the first class comprising synthetic images, and the second class comprising ground truth images, and
      output a classification result,
   wherein a saliency map relating to the received image(s) is generated from the critic based on the classification result, and
   wherein a loss function is used to minimize deviations between the at least one synthetic image and the corresponding ground truth image at least partially on the basis of the saliency map.

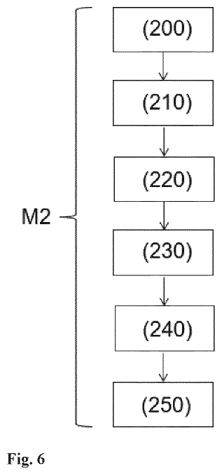

FIG. 6 shows schematically and exemplarily another embodiment of the method according to the present invention in the form of a flow chart. The method M2 comprises the steps:
(200) providing an actor-critic framework comprising an actor and a critic,
(210) training the actor-critic framework based on training data comprising a multitude of datasets, each dataset comprising i) an input dataset and ii) a corresponding ground truth image,
   wherein the actor is trained to:
      generate, for each dataset, at least one synthetic image from the input dataset,
   wherein the critic is trained to:
      receive the at least one synthetic image and/or the corresponding ground truth image,
      classify the received image(s) into one of two classes, a first class and a second class, the first class comprising synthetic images, and the second class comprising ground truth images, and
      output a classification result,
   wherein a saliency map relating to the received image(s) is generated from the critic based on the classification result,
   wherein a loss function is used to minimize deviations between the at least one synthetic image and the corresponding ground truth image at least partially on the basis of the saliency map,
(220) receiving a new input dataset,
(230) inputting the new input dataset into the actor,
(240) receiving from the actor a new synthetic image, and
(250) outputting the new synthetic image.

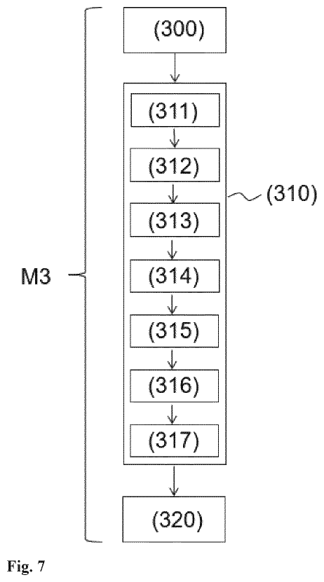

FIG. 7 shows schematically and exemplarily an embodiment of the method according to the present invention in the form of a flow chart. The method M3 comprises the steps:
(300) providing an actor-critic framework comprising an actor and a critic,
(310) training the actor critic framework based on training data comprising a multitude of datasets, each dataset comprising i) an input dataset and ii) a corresponding ground truth image, wherein the training comprises the following sub-steps:
   (311) inputting an input dataset into the actor,
   (312) receiving from the actor a synthetic image,
   (313) inputting the synthetic image and/or a ground truth image corresponding to the input dataset into the critic,
   (314) receiving from the critic a classification result, the classification result indicating whether the image inputted into the critic is classified as a synthetic image or as a ground truth image,
   (315) generating a saliency map related to the image inputted into the critic based on the classification result,
   (316) computing a loss value by using a loss function, wherein the loss function quantifies the deviations between the synthetic image and the ground truth image, wherein the loss function is at least partially based on the saliency map, and
   (317) modifying parameters of the actor critic framework to reduce the loss value, and
(320) storing the trained actor as a predictive machine learning model for generating a synthetic image on the basis of an input dataset.

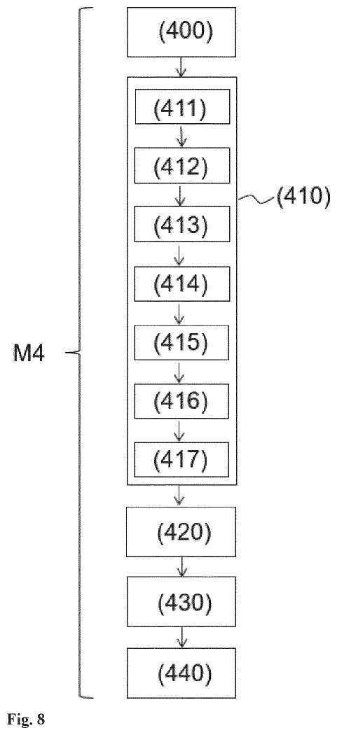

FIG. 8 shows schematically and exemplarily another embodiment of the method according to the present invention in the form of a flow chart. The method M4 comprises the steps:
(400) providing an actor-critic framework comprising an actor and a critic,
(410) training the actor critic framework based on training data comprising a multitude of datasets, each dataset comprising i) a first image of an examination region of an examination object, wherein the first image shows the examination region with no contrast agent administered to the examination object or after a first dose of a contrast agent was administered to the examination object, ii) a second image of the examination region of the examination object, wherein the second image shows the examination region after a second dose of the contrast agent was administered to the examination object, and iii) a third image of the examination region of the examination object, wherein the third image shows the examination region after a third dose of the contrast agent was administered to the examination object, wherein the second does is greater than the first dose, and the third dose is greater than the second dose, and wherein the training comprises, for each dataset, the following sub-steps:
   (411) inputting the first image and the second image into the actor,
   (412) receiving from the actor a synthetic third image,
   (413) inputting the synthetic third image and/or the third image into the critic,
   (414) receiving from the critic a classification result, the classification result indicating whether the image inputted into the critic is a synthetic image or not,
   (415) generating a saliency map related to the image inputted into the critic on the basis of the classification result,
   (416) computing a loss value by using a loss function, wherein the loss function quantifies the deviations between the synthetic third image and the third image, wherein the loss function is at least partially based on the saliency map, and
   (417) modifying parameters of the actor critic framework to reduce the loss value,
(420) receiving a new input dataset, the new input dataset comprising i) a first image of the examination region of a new examination object, wherein the first image shows the examination region with no contrast agent administered to the new examination object or after a first dose of a contrast agent was administered to the new examination object, ii) a second image of the examination region of the new examination object, wherein the second image shows the examination region after a second dose of the contrast agent was administered to the new examination object,
(430) inputting the new input dataset into the actor, and
(440) receiving from the actor a synthetic third image, the synthetic third image showing the examination region after a third dose of the contrast agent was administered to the new examination object.

The examination object is preferably a human being, e.g., a patient. The examination region may be a part of the human being, such as the thorax, the lungs, the heart, the brain, the liver, the kidney, the intestine or any other organ or any other part of the human body. The examination object may be subjected to a radiological examination. The images used for training and prediction may be radiological images such as, e.g., computed tomography scans or magnetic resonance imaging scans. The contrast agent may be a contrast agent used for computed tomography (e.g., a iodine-containing solution) or a contrast agent used for magnetic resonance imaging (e.g., a gadolinium chelate).

Further embodiments of the present invention are:
1. A method of training a predictive machine learning model to generate a synthetic image, the method comprising:
   receiving training data comprising a multitude of datasets, each dataset comprising i) an input dataset and ii) a corresponding ground truth image, and
   training an artificial neural network system to generate synthetic images from the input datasets,
      wherein the artificial neural network system comprises an actor neural network and a critic neural network,
      wherein the actor neural network is trained to generate, for each dataset, at least one synthetic image from the input dataset, and output the at least one synthetic image,
      wherein the critic neural network is trained to receive the at least one synthetic image and the corresponding ground truth image, and to classify the received images into one of two classes, a first class and a second class, the first class comprising synthetic images, and the second class comprising ground truth images,
      wherein a saliency map is generated from the critic neural network, and
      wherein a loss function is used to minimize deviations between the synthetic image and the ground truth image on the basis of the synthetic image, the ground truth image and the saliency map.
2. The method according to embodiment 1, wherein each dataset of the multitude of datasets belongs to a subject or an object.
3. The method according to embodiment 2, wherein each subject is a patient and the ground truth image of each subject is at least one medical image of the patient.
4. The method according to any one of the embodiments 1 to 3, wherein the subject is a patient, and the input dataset comprises at least one medical image of the patient.
5. The method according to any one of the embodiments 1 to 4, wherein the input dataset of each dataset of the multitude of datasets comprises i) a medical image and ii) a segmented medical image, wherein the predictive machine learning model is trained to generate synthetically segmented medical images from medical images.
6. The method according to any one of the embodiments 1 to 4, wherein the input dataset of each dataset of the multitude of datasets comprises i) an MRI images and ii) a CT image, wherein the predictive machine learning model is trained to generate synthetic CT images from MRI images.
8. The method according to any one of the embodiments 1 to 4, wherein the input dataset of each dataset of the multitude of datasets comprises i) a zero-contrast image, ii) a low-contrast image, and ii) a full-contrast image, wherein the predictive machine learning model is trained to generate synthetic full-contrast images from zero-contrast and low-contrast images.
9. The method according to any of the embodiments 1 to 8, wherein the artificial neural network system comprises two inputs layers, a first input layer and a second input layer, and two output layers, a first output layer and a second output layer,
   wherein the first input layer is configured to receive, for each dataset of the multitude of datasets, the input dataset,
   wherein the first output layer is configured to output, for each dataset of the multitude of datasets, the synthetic image,
   wherein the second input layer is configured to receive, for each dataset of the multitude of datasets, the synthetic image and the ground truth image, and
   wherein the second output layer is configured to output, for each image received via the second input layer, a classification result indicating whether the received image is a synthetic image or a ground truth image.
10. The method according to any of the embodiments 1 to 9, wherein the saliency map is created by taking the gradient of the output of the critic neural network with respect to the input image.
11. The method according to any of the embodiments 1 to 10, wherein the loss function is computed by multiplying a pixel-wise loss function with the saliency map.
12. A computer system comprising
   a receiving unit,
   a processing unit, and
   an output unit,
wherein the processing unit is configured to:
   receive, via the receiving unit, training data comprising a multitude of datasets, each dataset comprising i) an input dataset and ii) a corresponding ground truth image, and
   train an artificial neural network system to generate synthetic images from the input datasets,
      wherein the artificial neural network system comprises an actor neural network and a critic neural network,
      wherein the actor neural network is trained to generate, for each dataset, at least one synthetic image from the input dataset, and output the at least one synthetic image,
      wherein the critic neural network is trained to receive the at least one synthetic image and the corresponding ground truth image, and to classify the received images into one of two classes, a first class and a second class, the first class comprising synthetic images, and the second class comprising ground truth images,
      wherein a saliency map is generated from the critic neural network, and
      wherein a loss function is used to minimize deviations between the synthetic image and the ground truth image on the basis of the synthetic image, the ground truth image and the saliency map.
13. A non-transitory computer-readable storage medium storing instructions for training a predictive machine learning model to generate a synthetic image that, when executed by one or more processors of an electronic device, cause the device to:
   receive training data comprising a multitude of datasets, each dataset comprising i) an input dataset and ii) a corresponding ground truth image, and
   train an artificial neural network system to generate synthetic images from the input datasets,
      wherein the artificial neural network system comprises an actor neural network and a critic neural network,
      wherein the actor neural network is trained to generate, for each dataset, at least one synthetic image from the input dataset, and output the at least one synthetic image,
      wherein the critic neural network is trained to receive the at least one synthetic image and the corresponding ground truth image, and to classify the received images into one of two classes, a first class and a second class, the first class comprising synthetic images, and the second class comprising ground truth images,
      wherein a saliency map is generated from the critic neural network, and
      wherein a loss function is used to minimize deviations between the synthetic image and the ground truth image on the basis of the synthetic image, the ground truth image and the saliency map.
14. A method of generating a synthetic image, the method comprising:
   receiving an input dataset,
   inputting the input dataset into a predictive machine learning model,
   receiving from the predictive machine learning model the synthetic image, and
   outputting the synthetic image,
wherein the predictive machine learning model was trained according to the method as defined in any one of the embodiments 1 to 11.
15. A computer system comprising:
   a receiving unit,
   a processing unit, and
   an output unit,
wherein the processing unit is configured to:
   receive, via the receiving unit, an input dataset,
   input the input dataset into a predictive machine learning model,
   receive from the predictive machine learning model the synthetic image, and
   output the synthetic image via the output unit,
   wherein the predictive machine learning model was trained according to the method as defined in any one of the embodiments 1 to 11.
16. A non-transitory computer-readable storage medium storing instructions for generating a synthetic image that, when executed by one or more processors of an electronic device, cause the device to:
   receive an input dataset,
   input the input dataset into a predictive machine learning model, and
   receive from the predictive machine learning model the synthetic image,
wherein the predictive machine learning model was trained according to the method as defined in any one of the embodiments 1 to 11.
17. A method for generating a synthetic image, the method comprising:
   receiving an input dataset,
   inputting the input dataset into a predictive machine learning model,
   receiving from the predictive machine learning model the synthetic image, and
   outputting the synthetic image,
wherein the predictive machine learning model was trained in a supervised learning based on training data to generate synthetic images from input datasets, wherein the training data comprised a multitude of datasets, each dataset comprising i) an input dataset and ii) a corresponding ground truth image,
wherein for the training the predictive machine learning model was connected in a neural network system with a critic neural network,
wherein the critic neural network was configured to receive synthetic images generated by the predictive machine learning model and ground truth images and it was trained to classify the received images into one of two classes, a first class and a second class, the first class comprising synthetic images, and the second class comprising ground truth images,
wherein saliency maps were generated from the critic neural network on the basis of inputted images, and
wherein a loss function was used in the training to minimize deviations between synthetic images and ground truth images on the basis of the synthetic images, the ground truth images and the saliency maps.
18. A computer system comprising:
   a receiving unit,
   a processing unit, and
   an output unit,
wherein the processing unit is configured to:
   receive, via the receiving unit, an input dataset,
   input the input dataset into a predictive machine learning model,
   receive from the predictive machine learning model the synthetic image, and
   output the synthetic image via the output unit,
wherein the predictive machine learning model was trained in a supervised learning based on training data to generate synthetic images from input datasets, wherein the training data comprised a multitude of datasets, each dataset comprising i) an input dataset and ii) a corresponding ground truth image,
wherein for the training the predictive machine learning model was connected in a neural network system with a critic neural network,
wherein the critic neural network was configured to receive synthetic images generated by the predictive machine learning model and ground truth images and it was trained to classify the received images into one of two classes, a first class and a second class, the first class comprising synthetic images, and the second class comprising ground truth images,
wherein saliency maps were generated from the critic neural network, and
wherein a loss function was used in the training to minimize deviations between synthetic images and ground truth images on the basis of the synthetic images, the ground truth images and the saliency maps.
19. A non-transitory computer-readable storage medium storing instructions for generating a synthetic image that, when executed by one or more processors of an electronic device, cause the device to:
   receive an input dataset,
   input the input dataset into a predictive machine learning model,
   receive from the predictive machine learning model the synthetic image, and
   output the synthetic image,
wherein the predictive machine learning model was trained in a supervised learning based on training data to generate synthetic images from input datasets, wherein the training data comprised a multitude of datasets, each dataset comprising i) an input dataset and ii) a corresponding ground truth image,
wherein for the training the predictive machine learning model was connected in a neural network system with a critic neural network,
wherein the critic neural network was configured to receive synthetic images generated by the predictive machine learning model and ground truth images and it was trained to classify the received images into one of two classes, a first class and a second class, the first class comprising synthetic images, and the second class comprising ground truth images,
wherein saliency maps were generated from the critic neural network, and
wherein a loss function was used in the training to minimize deviations between synthetic images and ground truth images on the basis of the synthetic images, the ground truth images and the saliency maps.

1. A computer-implemented method comprising:
providing an actor-critic framework comprising an actor and a critic;
training the actor-critic framework based on training data comprising a multitude of datasets, each dataset comprising an input dataset and a corresponding ground truth image, wherein training the actor-critic framework comprises:
training the actor to generate, for each dataset, at least one synthetic image from the input dataset,
training the critic to:
receive the at least one synthetic image and/or the corresponding ground truth image,
classify the received image(s) into one of two classes, the two classes comprising a first class and a second class, the first class comprising synthetic images, and the second class comprising ground truth images, and
output a classification result,
wherein a saliency map relating to the received image(s) is generated from the critic based on the classification result, and
wherein a loss function is used to minimize deviations between the at least one synthetic image and the corresponding ground truth image at least partially based on the saliency map.

2. The method of claim 1, further comprising:
storing the actor in a data storage.

3. The method of claim 1, wherein the actor is or comprises an artificial neural network, preferably a convolutional neural network.

4. The method according to claim 1, wherein the critic is or comprises an artificial neural network, preferably a convolutional neural network.

5. The method according to claim 1, wherein the saliency map is generated by taking a gradient of the classification result with respect to the received image(s).

6. The method according to claim 1, wherein the saliency map is generated from gradient maps related to the at least one synthetic image and to the corresponding ground truth image.

7. The method according to claim 1, wherein the loss function is computed by multiplying a pixel-wise loss function with the saliency map.

8. The method according to claim 1, further comprising:
receiving a new input dataset;
inputting the new input dataset into the actor;
receiving from the actor a new synthetic image; and
outputting the new synthetic image.

9. The method according to claim 1, wherein each dataset of the multitude of datasets belongs to a subject or an object.

10. The method of claim 9, wherein each subject is a patient and the ground truth image of each subject is at least one medical image of the patient.

11. The method of claim 9, wherein the subject is a patient, and the input dataset comprises at least one medical image of the patient.

12. The method of claim 1, wherein the input dataset of each dataset of the multitude of datasets comprises a medical image and a segmented medical image, wherein the actor is trained to generate synthetically segmented medical images from the medical images.

13. The method of claim 1, wherein the input dataset of each dataset of the multitude of datasets comprises a zero-contrast image, a low-contrast image, and a full-contrast image, wherein the actor is trained to generate synthetic full-contrast images from the zero-contrast and the low-contrast images.

14. A computer system comprising one or more processors configured to:
receive an input dataset;
input the input dataset into a predictive machine learning model;
receive from the predictive machine learning model a synthetic image; and
output the synthetic image via the output unit,
wherein the predictive machine learning model was trained in a training process to generate synthetic images from input datasets, the training process comprising:
receiving training data comprising a multitude of datasets, each dataset comprising an input dataset and a corresponding ground truth image;
providing an actor-critic framework comprising an actor and a critic;
training the actor-critic framework based on the training data, wherein training the actor-critic framework comprises:
training the actor to:
generate, for each dataset, at least one synthetic image from the input dataset, and
output the at least one synthetic image,
training the critic to:
receive the at least one synthetic image and/or the corresponding ground truth image, and
output a classification result for each received image, wherein the classification result indicates whether the received image is a synthetic image or a ground truth image;
wherein a saliency map relating to the received image(s) is generated from the critic based on the classification result, and
wherein a loss function is used to minimize deviations between the at least one synthetic image and the corresponding ground truth image at least partially based on the saliency map.

15. A non-transitory computer-readable storage medium storing instructions for generating a synthetic image that, when executed by one or more processors of an electronic device, cause the device to:
receive an input dataset;
input the input dataset into a predictive machine learning model;
receive from the predictive machine learning model a synthetic image; and
output the synthetic image,
wherein the predictive machine learning model was trained in a training process to generate synthetic images from input datasets, the training process comprising:
receiving training data comprising a multitude of datasets, each dataset comprising an input dataset and a corresponding ground truth image;
providing an actor-critic framework comprising an actor and a critic;
training the actor-critic framework based on the training data, wherein training the actor-critic framework comprises:
training the actor to:
generate, for each dataset, at least one synthetic image from the input dataset, and
output the at least one synthetic image,
training the critic to:
receive the at least one synthetic image and/or the corresponding ground truth image, and
output a classification result for each received image, wherein the classification result indicates whether the received image is a synthetic image or a ground truth image;
wherein a saliency map relating to the received image(s) is generated from the critic based on the classification result, and
wherein a loss function is used to minimize deviations between the at least one synthetic image and the corresponding ground truth image at least partially based on the saliency map.
